(19) United States
(12) Patent Application Publication
(10) Pub. No.: US 2015/0195341 A1
(43) Pub. Date: Jul. 9, 2015

(54) SYSTEMS AND METHODS FOR ACCESSING WEB CONTENT

(71) Applicants: Andrew Swerdlow, San Francisco, CA (US); Dan Fredinburg, San Francisco, CA (US)

(72) Inventors: Andrew Swerdlow, San Francisco, CA (US); Dan Fredinburg, San Francisco, CA (US)

(73) Assignee: Google Inc., Mountain View, CA (US)

(21) Appl. No.: 13/465,986

(22) Filed: May 7, 2012

(51) Int. Cl. H04L 29/08; G06F 3/0484; G06F 15/16

(52) U.S. Cl. CPC H04L 67/10; H04L 67/02; G06F 3/0484

(57) ABSTRACT

A system and method for accessing web content are provided. In one aspect, a method includes providing an interface on a web browsing application to display a plurality of virtual locations, receiving a user selection of a virtual location from the plurality of virtual locations, selecting an accessible server from a plurality of accessible servers in or near a physical location corresponding to the selected virtual location, requesting an origin server to route a request to access web content to the selected server, wherein web content corresponds to content for an electronic device located in or near the physical location corresponding to the selected virtual location, receiving, in response to the request, the web content from the selected server, and providing the received web content for display on the web browsing application, wherein the web content is different than the web content corresponding to a physical location of the user.

### FIELD

The subject technology generally relates to accessing web content, and, in particular, relates to accessing web content on a web browsing application.

### BACKGROUND

A user's internet experience often changes depending on the user's geographical location. In particular, the user can access web content located at a URL in different geographical locations and receive different formats and different content of the same web content from the same URL depending on the geographical locations.

### SUMMARY

The disclosed subject technology relates to a computer-implemented for accessing web content. The method comprises providing an interface on a web browsing application to display a plurality of virtual locations. The method also comprises receiving a user selection of a virtual location from the plurality of virtual locations. The method also comprises selecting an accessible server from a plurality of accessible servers in or near a physical location corresponding to the selected virtual location. The method also comprises requesting an origin server to route a request to access web content to the selected accessible server, wherein the web content corresponds to content for an electronic device located in or near the physical location corresponding to the selected virtual location. The method also comprises receiving, in response to the request, the web content from the selected accessible server, wherein the web content corresponds to content for an electronic device located in or near the physical location corresponding to the selected virtual location. The method also comprises providing the received web content for display on the web browsing application, wherein the web content is different than the web content corresponding to a physical location of the user.

The disclosed subject matter further relates to a system for accessing web content. The system comprises one or more processors, and a machine-readable medium comprising instructions stored therein, which when executed by the processors, cause the processors to perform operations comprising providing an interface on a web browsing application to display a plurality of virtual locations. The operations further comprise receiving a user selection of a virtual location from the plurality of virtual locations. The operations further comprise selecting an accessible server from a plurality of accessible servers in or near a physical location corresponding to the selected virtual location, wherein selecting the accessible server is based on a distance between a physical location corresponding to the selected virtual location and respective physical locations of each of the plurality of the accessible servers. The operations further comprise establishing a connection with an origin server. The operations further comprise requesting the origin server to route a request to access web content to the selected accessible server, wherein the web content corresponds to content for an electronic device located in or near the physical location corresponding to the selected virtual location. The operations further comprise receiving, in response to the request, the web content from the selected accessible server, wherein the web content corresponds to content for an electronic device located in or near the physical location corresponding to the selected virtual location. The operations further comprise providing the received web content for display on the web browsing application, wherein the web content is different than the web content corresponding to a physical location of the user.

The disclosed subject matter further relates to a machine readable medium comprising instructions stored therein, which when executed by a system, cause the system to perform operations comprising providing an interface on a web browsing application to display a plurality of virtual locations. The operations further comprise receiving a user selection of a virtual location from the plurality of virtual locations. The operations further comprise selecting a content distribution network from a plurality of content distribution networks in or near a physical location corresponding to the selected virtual location, wherein selecting the content distribution network is based on a distance between a physical location corresponding to the selected content distribution network and respective physical locations of each of the plurality of the content distribution networks. The operations further comprise establishing a connection with an origin server. The operations further comprise requesting the origin server to route a request to access web content to the selected content distribution network, wherein the web content corresponds to content for an electronic device located in or near the physical location corresponding to the selected virtual location. The operations further comprise receiving, in response to the request, the web content from the selected content distribution network, wherein the web content corresponds to content for an electronic device located in or near the physical location corresponding to the selected virtual location. The operations further comprise providing the received web content for display on the web browsing application, wherein the web content is different than the web content corresponding to a physical location of the user. The operations further comprise providing an indicator of the selected content distribution network's physical location for display on an interface of the web browsing application, wherein the indicator is a flag of a country the content distribution network is physically located in.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example distributed network environment which can access web content.

FIG. 2 illustrates an example process for accessing web content.

FIG. 3A illustrates an example screenshot of an interface for displaying a plurality of virtual locations on a web browsing application running on an electronic device.

FIG. 3B illustrates an example screenshot of an interface for displaying a plurality of virtual locations on a web browsing application running on an electronic device, where the interface is configured to receive a user input of a user designated virtual location.

FIG. 4 illustrates an example screenshot of web content transmitted from a selected accessible server having a physical location that is in or near a designated virtual location.

FIG. 5 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Although many examples provided herein describe a user's information being stored in memory, the user can, in example aspects, delete the user information from memory and/or opt out of having the user information stored in memory. Additionally, the user can, in example aspects, adjust privacy settings to selectively limit the types of user information stored in memory, or select the memory in which the user information is stored (e.g., locally on the user's electronic device as opposed to remotely a server). In some examples, the user information does not include and/or share the specific identification of the user (e.g., the user's name) unless otherwise specifically provided or directed by the user.

In accordance with the subject disclosure, a system and a method are provided for accessing web content. The disclosed subject matter configures a web browsing application running on an electronic device to provide an interface for displaying one or more virtual locations. The one or more virtual locations can represent a broad geographical region such as a country (e.g., France), or a specific geographical location (e.g., a city or a specific attraction such as the Golden Gate Bridge). Alternatively, the web browsing application can be configured to receive a user input of a user designated location. For example, the user can designate a specific or a general virtual location the user wishes to select. Additionally, the web browsing application can provide a map to allow the user to designate a specific virtual location through a user interaction with the provided map. Furthermore, the web browsing application may provide a user selectable control that is permanently displayed on the web browsing application (e.g., an input box on a tool bar). This user selectable control may be configured to receive a user input of a user designated location.

Upon receipt of a user selection of a virtual location, a comparison of the selected virtual location with physical locations of one or more accessible servers is made to determine which of the one or more accessible servers is most suitable to provide the user with the web content. Accessible servers can include content distribution networks, proxy servers, remote servers, or any other system that can host and provide the web content to the user's web browsing application. The comparison can be based on a distance between a physical location that corresponds to the selected virtual location and the physical locations of the one or more accessible servers.

The user may subsequently elect a different virtual location from the plurality of virtual locations. Where a different user selection of a virtual location from the plurality of virtual locations is received, a different accessible server may be selected from the plurality of accessible servers in or near a physical location corresponding to the newly selected virtual location.

Upon selection of a server from the one or more accessible servers, the web browsing application establishes connection with an origin server (e.g., a local server, a local router, a content distribution network located in or near the user's physical location, or a default server for accessing the web content at the user's physical location) and requests the origin server to route a request to access the web content as well as subsequently transmitted web traffic to the selected accessible server. The request contains information about the electronic device (e.g., the electronic device's IP address) and the selected accessible server (e.g., the selected accessible server's IP address). This can cause the selected accessible server to provide web content to the web browsing application as if the selected accessible server is providing the web content to a web browsing application running on a device located at a physical location corresponding to the selected virtual location. Where the selected accessible server and the electronic device are located in different physical locations, web content provided from the selected accessible server for display on the web browsing application may be different than the web content that would have been provided to the user at the user's physical location. Therefore, the user may designate a virtual location and receive web content in a format that would be provided to the user as if the user is located in a physical location corresponding to the designated virtual location regardless of the user's actual physical location.

One or more tunneling protocols may be used to establish connection between the electronic device, the origin server, and the selected accessible server. Example tunneling protocols may include, but are not limited to, Secure Socket Layer (SSL) tunneling, Secure Shell (SSH) tunneling, HTTP tunneling, and FTP tunneling. Furthermore, transmission of web content between the electronic device, the origin server, and the selected accessible server may be maintained by tunneling protocols (e.g., SSL tunneling, SSH tunneling, HTTP tunneling, FTP tunneling, etc.). Transmission of web content between the electronic device, the origin server, and the selected accessible server may also be handled by the one or more tunneling protocols. Additional communication protocols (e.g., TCP/IP, etc.) may also be used to establish and maintain connection between the electronic device, the origin server, and the selected accessible server.

Subsequent web traffic transmitted from the user's web browsing application may be routed to the selected accessible server regardless of the user's physical location. Furthermore, subsequent web traffic received by the user's web browsing application may be transmitted from the selected accessible server regardless of the user's physical location. The user's electronic device Internet Protocol (IP) address and browser HTTP language settings may be modified based on the physical location of the selected accessible server to facilitate this process. The user's web traffic may continue to be routed to and from the selected accessible server until the user selects a different virtual location. Alternatively, routing of the user's web traffic to the selected accessible server can end when the web browsing application is closed.

The web browsing application can be configured to provide a visual representation and/or context information for display to notify the user while web traffic is routed to the selected accessible server. The visual representation can include a flag or any other icon that correlates with the selected accessible server's physical location. For example, the web browsing application can be configured to provide a flag that represents a country the selected accessible server is located in for display in the web browsing application's input field, next to the Uniform Resource Locator (URL) line. Additional visual representations and/or context information can be utilized to alert the user that web traffic is being routed to the selected accessible server.

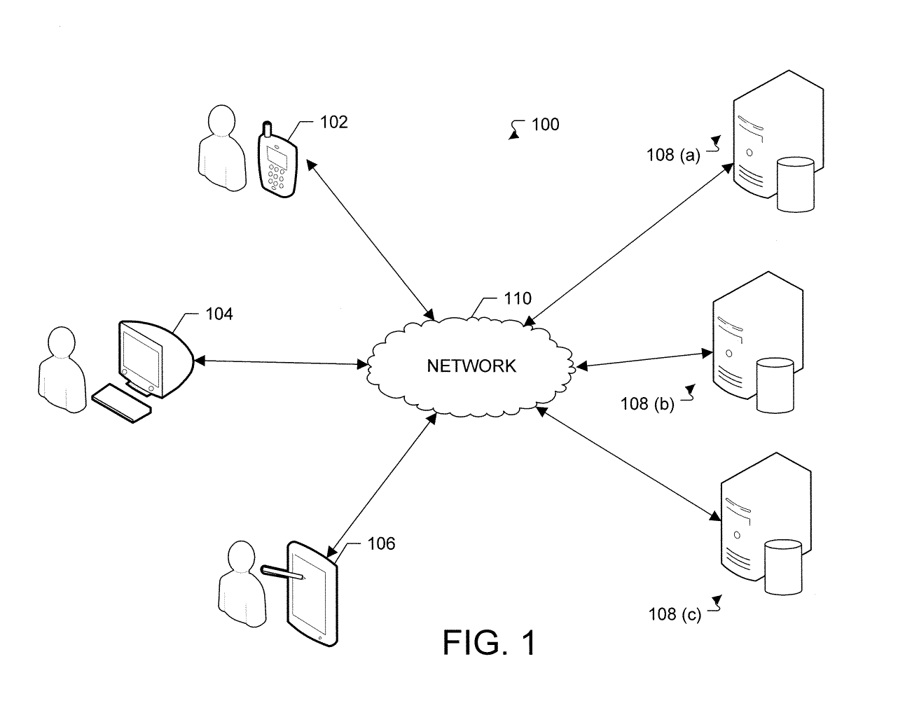

FIG. 1 illustrates an example distributed network environment which can access web content. A network environment 100 includes a number of electronic devices 102, 104, 106 communicably connected to servers 108(a), 108(b), 108(c) by a network 110.

In some example aspects, each of the electronic devices 102, 104, and 106 may include any machine with hardware and software to access web content. Electronic devices 102, 104, and 106 can be mobile devices (e.g., smartphones, tablet computers, PDAs, and laptop computers), portable media players, desktop computers or other computing devices. In the example of FIG. 1, electronic device 102 is depicted as a smartphone, electronic device 104 is depicted as a desktop computer, and electronic device 106 is depicted as a tablet computer.

Servers 108(a)-108(c) may be any system or device having a processor, memory, and communications capability for providing web content to electronic devices 102, 104, or 106. In some example aspects, servers 108(a)-108(c) can each represent a single computing device such as a computer server. In other embodiments, servers 108(a)-108(c) can each represent more than one computing device working together to perform the actions of a server computer (e.g., cloud computing). Each of the servers 108(a)-108(c) has an actual physical address.

In the example of FIG. 1, server 108(a) is depicted as an origin server, server 108(b) is depicted as a first accessible server, and server 108(c) is depicted as a second accessible server. The origin server may be a local server, a local router, or a default server for accessing the web content at the user's physical location. Accessible servers may include content distribution networks, proxy servers, remote servers, or any other system that can host and provide the web content to the user's web browsing application. The servers may include additional servers not depicted in FIG. 1.

Network 110 can include, for example, any one or more of a cellular network, a satellite network, a personal area network (PAN), a local area network (LAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

In some example aspects, each of the electronic devices 102, 104, and 106 may provide an interface on a web browsing application to display a plurality of virtual locations. Each of the plurality of virtual locations corresponds to a physical location. For example a virtual location may correspond to a country and may take on a country name (e.g., France, USA, etc.). The interface may also be configured to receive a user input of a user designated virtual location.

Each of the electronic devices 102, 104, and 106 may receive a user selection of a virtual location from the plurality of virtual locations. Each of the electronic devices 102, 104, and 106 may select an accessible server 108(b) or 108(c) from a plurality of accessible servers 108(b) and 108(c) in or near a physical location corresponding to the selected virtual location. Selection of an accessible server 108(b) or 108(c) may be based on a distance between a physical location corresponding to the selected virtual location and the respective physical locations of each of the plurality of accessible servers 108(b) and 108(c). For example, where the first accessible server 108(b) is physically located in France, and the second accessible server 108(c) is physically located in Germany, and the user chooses a virtual location that corresponds to a physical location in France, the user's electronic device 102, 104, or 106 would select the server 108(b) that is located in France. Each of the electronic devices 102, 104, and 106 may store server information (e.g., IP address of the servers, their physical location, etc.) within its hardware components (e.g., hard disk, RAM, ROM, etc.). Information regarding servers 108(a)-108(c) may also be stored on the servers 108(a)-108(c) and may be transmitted to the electronic devices 102, 104, and 106 via the network 110.

Each of the electronic devices 102, 104, and 106 may request origin server 108(a) to route a request to access web content to the selected accessible server 108(b) or 108(c), where the web content corresponds to content for an electronic device 102, 104, or 106 located in or near the physical location corresponding to the selected virtual location. Each of the electronic devices 102, 104, and 106 may modify its IP address to correspond to an IP address of an electronic device located in or near the physical location of the selected accessible server 108(b) or 108(c). Each of electronic devices 102, 104, and 106 may provide additional information (e.g., IP address of the selected accessible server, IP address of the electronic device, modified IP address of the electronic device etc.) to the origin server 108(a) and/or the selected accessible server 108(b) or 108(c).

Each of the electronic devices 102, 104, and 106 may establish a connection with the origin server. The connection may be established through one or more tunneling protocols (e.g., SSL tunneling, HTTP tunneling, FTP tunneling, etc.). Furthermore, each of the electronic devices 102, 104, and 106 may request the origin server 108(a) to route a request to access web content to one of the selected accessible servers 108(b) or 108(c), where the web content corresponds to content for an electronic device 102, 104, or 106 located in or near the physical location corresponding to the selected virtual location. Origin server 108(a) may request the selected accessible server 108(b) or 108(c) to transmit web content to the electronic device 102, 104, or 106, where the web content corresponds to content for an electronic device 102, 104, or 106 located in or near the physical location corresponding to the selected virtual location.

The selected accessible server 108(b) or 108(c) may receive instructions to transmit web content to the electronic device 102, 104, or 106 from the origin server 108(a). The selected accessible server 108(b) or 108(c) may transmit web content to the web browsing application running on the electronic device 110 where the web content corresponds to content for an electronic device 102, 104, or 106 located in or near the physical location corresponding to the selected virtual location. Where a communication is established through a tunneling protocol, transmission of web content between an electronic device 102, 104, or 106, the electronic device's origin server 108(a), and the selected accessible server 108(b) or 108(c) may be handled by the tunneling protocol.

Each of the electronic devices 102, 104, and 106 may receive, in response to the request, the web content from the selected accessible server 108(b) or 108(c), where the web content corresponds to content for an electronic device located in or near the physical location corresponding to the selected virtual location. Each of the electronic devices 102, 104, and 106 may provide the received web content for display on the web browsing application, where the received web content is different than the web content corresponding to a physical location of the user. The received web content may be identical to the web content that is provided to a web browsing application accessing the web content at the physical location of the selected accessible server 108(b) or 108(c). Each of the electronic devices 102, 104, and 106 may provide an indicator of the selected accessible server's physical location for display on an interface of the web browsing application running on the electronic devices 102, 104, and 106. The provided indicator may include a flag of a country the selected accessible server 108(b) or 108(c) is physically located in.

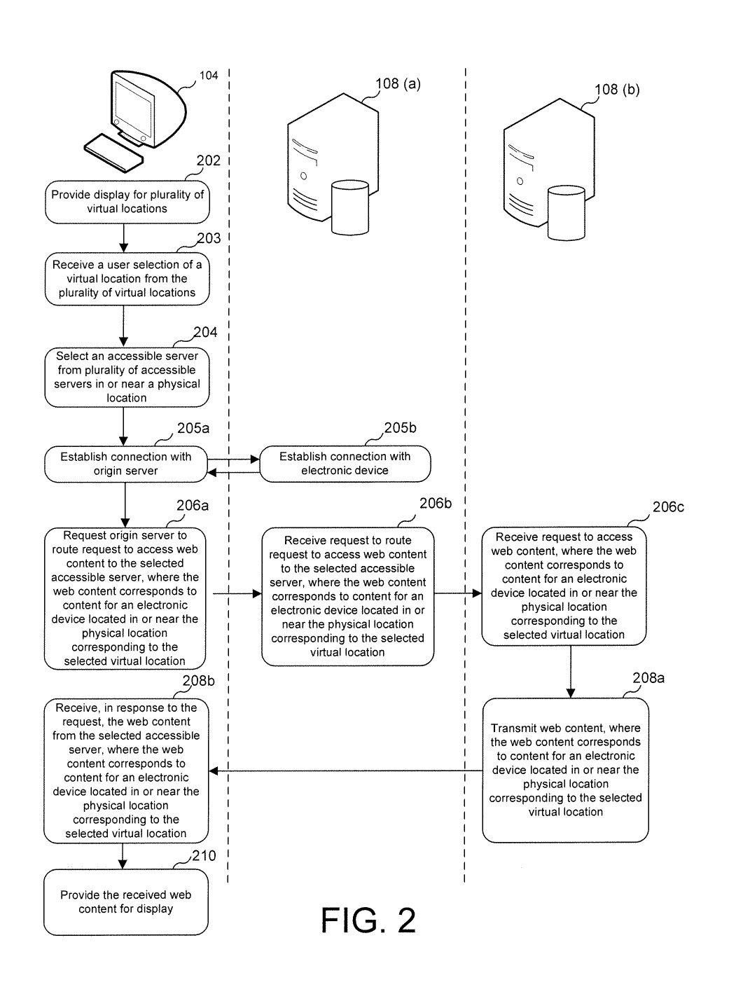

FIG. 2 illustrates an example process for accessing web content. In step 202, an interface is provided on a web browsing application running on an electronic device 104 to display a plurality of virtual locations for display on a web browsing application running on the electronic device 104. The user's electronic device 104 as shown in FIG. 2 is depicted as a desktop computer. The user's electronic device 104 can be mobile devices (e.g., smartphones, tablet computers, PDAs, and laptop computers), portable media players, or other computing devices. Additional applications (e.g., electronic message applications) may also provide one or more interfaces to display the plurality of virtual locations.

A virtual location may represent a country (e.g., take on a country name), a specific attraction, a city, etc. The interface may include a list of virtual locations. The user may select a virtual location from the list of virtual locations. Alternatively, the interface may receive a user input of a user designated virtual location. The interface may include a map feature that allows the user to interact with the map to designate a location on the map as the user designated virtual location. The user may select a virtual location through a user interaction (e.g., a click action, a hover action, a swipe action, a tap action, etc.) with an area on the map. The interface may also include an input field that allows the user to enter the user designated virtual location using the input field. The interface may also allow the user to designate a new virtual location.

In step 203, the electronic device 104 receives a user selection of a virtual location from the plurality of virtual locations. Where a web browsing application is running on the electronic device 104, the user selection of the virtual location is received by the web browsing application. In step 204, the electronic device 104 selects an accessible server 108(b) from a plurality of accessible servers in or near a physical location in response to a user selection of a virtual location from the plurality of virtual locations. Where a web browsing application is running on the electronic device 104, the selecting of an accessible server 108(b) may be performed by the web browsing application.

Accessible servers may include content distribution networks, proxy servers, remote servers, or any other system that can host and provide the web content to the user's web browsing application. Information regarding the accessible servers, including their physical locations may be stored locally on one or more of the electronic device's hardware components (e.g., hard drive, ROM, RAM, etc.). Alternatively, information regarding the accessible servers may be stored on a server and may be transmitted to the electronic device 104. The accessible server 108(b) may be selected based on a distance between a physical location corresponding to the selected virtual location and respective physical locations of each of the plurality of accessible servers. One or more applications (e.g., GPS, map application, distance calculator application) running on the electronic device 104 or running a server and accessible to the electronic device 104 may be used to determine the distance between a physical location corresponding to the selected virtual location and the respective physical locations of each of the plurality of accessible servers.

Where the user designates a new virtual location, the electronic device 104 may receive the newly designated virtual location and select a different accessible server from the plurality of accessible servers in or near a physical location corresponding to the newly designated virtual location. The new accessible server may be selected based on a distance between a physical location corresponding to the newly selected virtual location and the physical location of the user's electronic device 104.

In steps 205(a), and 205(b), the electronic device 104 establishes a connection with an origin server 108(a). This connection may be handled by one or more communication protocols (e.g., TCP/IP, one or more tunneling protocols, etc.). In steps 206(a), 206(b) and 206(c), the electronic device requests, the origin server 108(a) to route a request to access web content to the selected accessible server 108(b), where the web content corresponds to content for an electronic device located in or near the physical location corresponding to the selected virtual location. The web content may be identical to the web content corresponding to a web browsing application accessing the web content at the physical location of the selected accessible server. The origin server 108(a) may be a local server, a local router, a content distribution network located in or near the user's physical location, or a default server for accessing the web content at the user's physical location.

The request contains information about the electronic device (e.g., the electronic device's IP address) and the selected accessible server (e.g., the selected accessible server's IP address). The request also contains instructions to the origin server and the selected accessible server. The instructions to the origin server 108(a) may include information about the selected accessible server (e.g., the selected accessible server's IP address, physical location, etc.). The instructions to the selected accessible server 108(b) may include instructions related to transmitting web content to the electronic device, where the web content corresponds to content for an electronic device located in or near the physical location corresponding to the selected virtual location. The instructions to the selected accessible server may be transmitted to the origin server and routed from the origin server to the selected accessible server.

Transmission of web content between the electronic device 104, the origin server 108(a) and the selected accessible served 108(b) may be handled by tunneling protocols (e.g., SSL tunneling, SSH tunneling, HTTP tunneling, FTP tunneling, etc.). Transmission of web content between the electronic device, the origin server, and the selected accessible server may also be handled by the one or more tunneling protocols. Additional communication protocols (e.g., TCP/IP, etc.) may also be used to establish and maintain connection between the electronic device, the origin server and the selected accessible server. Electronic device 104 may modify its IP address at its physical location to correspond to an IP address of an electronic device located in or near the physical location of the selected accessible server 108(b). Where electronic device 104 modified its IP address, the instructions to the selected accessible server 108(b) may include the modified IP address.

The origin server 108(a) receives the request to route the request to access web content. The origin server 108(a), based on the instructions provided by the electronic device, communicates with the selected accessible server 108(b) and requests the selected accessible server to transmit the web content to the electronic device, where the web content corresponds to content for an electronic device located in or near the physical location corresponding to the selected virtual location. Where the electronic device 104 modified its IP address and provided the origin server 108(a) with its modified IP address, the origin server 108(a) may request the selected accessible server 108(b) to transmit web content to the modified IP address.

The selected accessible server 108(b) receives the request to transmit web content to the electronic device 104. The selected accessible server 108(b) may receive instructions that are provided by the electronic device via the origin server 108(a). The selected accessible server 108(b) may transmit web content to the electronic device as if the electronic device is located at a physical location corresponding to the selected virtual location. For example, where the selected accessible server 108(b) is located in France, the selected accessible server 108(b) may transmit web content to the electronic device as if the electronic device is also located in France. Where the electronic device modified its IP address and provided the origin server with its modified IP address, the selected accessible server 108(b) may transmit the web content to the modified IP address.

The electronic device 104 may continue to transmit one or more requests to the origin server 108(a) to route the request to access web content to the selected accessible server 108(b) until another accessible server from the plurality of accessible servers is selected in response to a user selection of another virtual location from the plurality of virtual locations. For example, the electronic device 104 may transmit one or more requests for the origin server 108(a) to route a request to access the web content to the selected accessible server each time the electronic device 104 requests access to web content. However, if the electronic device 104 receives a new user selection of a different virtual location from the plurality of virtual locations, the electronic device 104 may select a different accessible from the plurality of accessible servers in or near a physical location corresponding to the selected virtual location in response to the new user selection. Where the electronic device 104 selects a new accessible server, the electronic device 104 will request the origin server 108(a) to route subsequent requests to access web content to the newly selected accessible server.

In step 208(a) the selected accessible server 108(b) transmits the web content to the electronic device, where the web content corresponds to content for an electronic device located in or near the physical location corresponding to the selected virtual location. In step 208(b), the electronic device 104 receives the web content from the selected accessible server 108(b), where the web content corresponds to content for an electronic device located in or near the physical location corresponding to the selected virtual location. The electronic device 104 may continue to receive web content from the selected accessible server until another accessible server from the plurality of accessible servers in or near a physical location is selected in response to a user selection of another virtual location from the plurality of virtual locations.

In step 210, the received web content is provided for display on the web browsing application. The received web content may be different from the web content that would have been provided to the user at the user's physical location. Furthermore, the received web content may be identical to the web content corresponding to a web browsing application accessing the web content at the physical location of the selected accessible server 108(b). The web browser language settings may be modified to adopt an official language used in or around the physical location of the selected accessible server 108(b). Additional web browsing application settings may be configured to provide a fully localized experience.

The web browsing application may provide an indicator of the selected accessible server's physical location for display on an interface of the web browsing application. The indicator may include a flag of a country the selected accessible server 108(b) is physically located in. The indicator may include other textual and or visual representations that can serve a dual purpose to enrich the user's experience while receiving web content as the user would have received the web content if the user is in or near the physical location of the selected accessible server 108(b) and also to remind the user that the user is accessing web content through the selected accessible server 108(b).

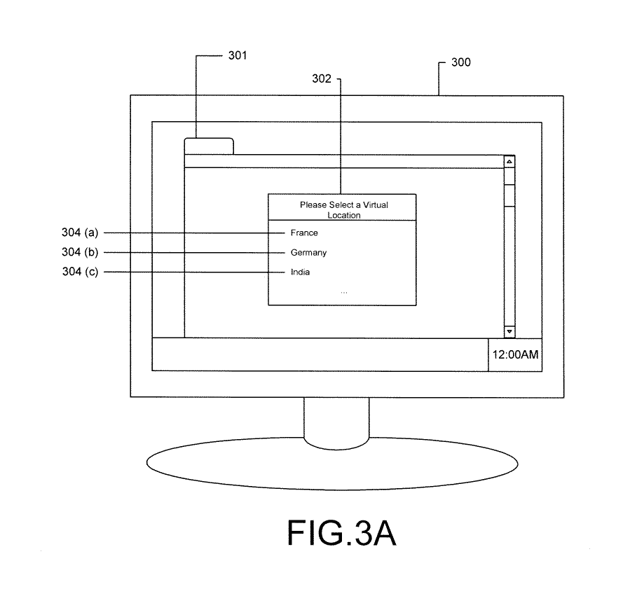

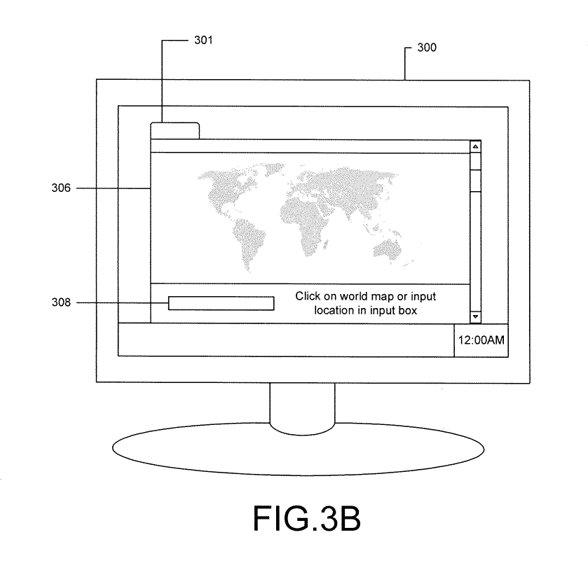

FIG. 3A illustrates an example screenshot of an interface for displaying a plurality of virtual locations on a web browsing application running on an electronic device 300 according to certain aspects of the disclosure. Web browsing application 301 can be any application configured to provide an interface for displaying web content transmitted from servers via network. The web browsing application as shown in FIG. 3A provides an interface to display a list 302 containing a plurality of virtual locations 304(a), 304(b), and 304(c). Virtual locations 304(a), 304(b), and 304(c) represent countries. Selection of “France” 304(a) may result in selection of an accessible server physically located in or near France. Alternatively, selection of “Germany” 304(b) may result in selection of an accessible server physically located in or near Germany. Selection of India 304(c) may result in selection of an accessible server physically located in or near India. Additional example interfaces may contain a different number of virtual locations. Additional example interfaces may provide virtual locations that correspond to a more specific geographical location such as a city or a place of interest. Virtual locations may be presented in one or more formats that allow the user to select a virtual location from the plurality of virtual locations.

FIG. 3B illustrates an example screenshot of an interface for displaying a plurality of virtual locations on a web browsing application running on an electronic device 300, where the interface is configured to receive a user input of a user designated virtual location according to certain aspects of the disclosure. The web browsing application 301 as shown in FIG. 3B contains a world map 306 and an input field 308. A user interaction (e.g., a click action, a hover action, a swipe action, a tap action, etc) with an area on the world map may result in selection of an accessible server physically located in or near a geographical location that corresponds to the selected area on the world map. Additional example interfaces may incorporate other maps or images that correspond to one or more virtual locations. Alternatively, a user input of a virtual location in the input field 308 may result in selection of a accessible server physically located in or near a physical location that corresponds to the inputted virtual location.

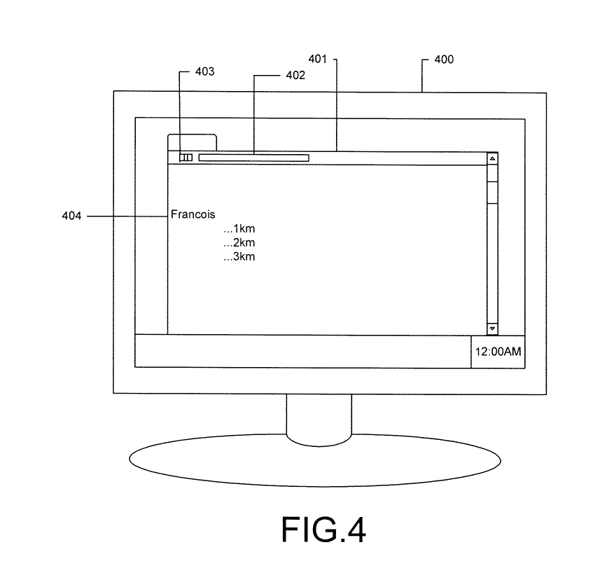

FIG. 4 illustrates an example screenshot of web content transmitted from a selected accessible server having a physical location that is in or near a designated virtual location according to certain aspects of the disclosure. Web browsing application 401 running on an electronic device 400 as shown in FIG. 4 provides web content transmitted from a selected accessible server located in France. An indicator 403 containing the French flag is displayed next to the URL field 402. Additional examples may include indicators displayed at another location with respect to the web browsing application's interface. Browser language setting of the web browsing application as shown in FIG. 4 has been changed to French to correspond to the physical location of the selected accessible server. The provided web content 404 as shown in FIG. 4 is identical to the web content that is be provided to a web browsing application accessing the web content in or near the physical location of the selected accessible server in France.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

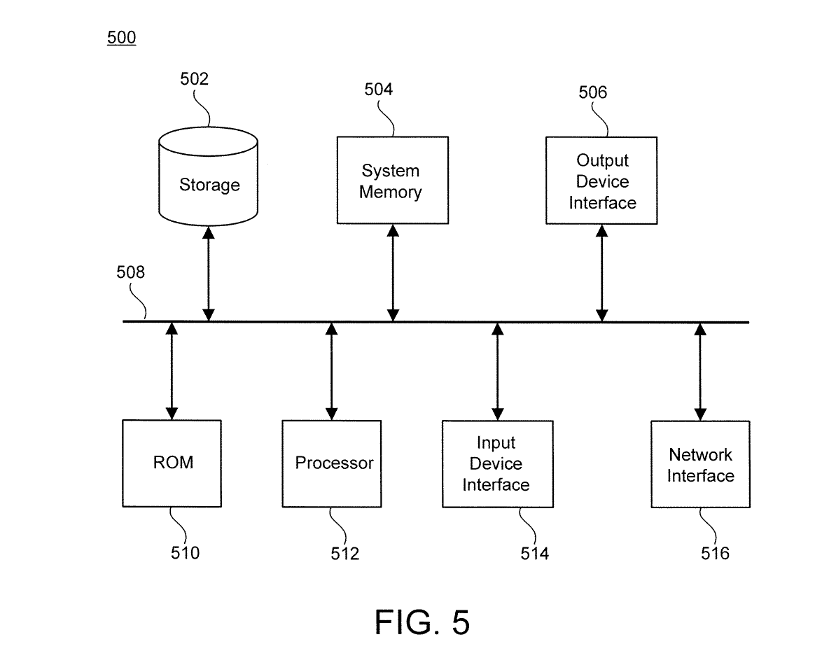

FIG. 5 conceptually illustrates an electronic system with which some implementations of the subject technology are implemented. Electronic system 500 can be a laptop computer a desktop computer, smartphone, PDA, a tablet computer or any other sort of device 102, 104, or 106. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, and/or ROM 510. For example, the various memory units include instructions accessing web content in accordance with some implementations. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's electronic device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to an electronic device (e.g., for purposes of displaying data to and receiving user input from a user interacting with the electronic device). Data generated at the electronic device (e.g., a result of the user interaction) can be received from the electronic device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A computer-implemented method for accessing web content, the method comprising:
providing an interface on a web browsing application to display a plurality of virtual locations;
receiving a user selection of a virtual location from the plurality of virtual locations;
selecting an accessible server from a plurality of accessible servers, wherein each of the plurality of accessible servers is located in or near a physical location corresponding to the selected virtual location;
requesting an origin server to route a request to access first web content to the selected accessible server, wherein the origin server is located in or near a physical location of the user, and wherein the first web content corresponds to content received by an electronic device located in or near the physical location corresponding to the selected virtual location;
receiving, in response to the request, the first web content from the selected accessible server, wherein the first web content corresponds to content received by an electronic device located in or near the physical location corresponding to the selected virtual location; and
providing the received first web content for display on the web browsing application, wherein the first web content is different than second web content, wherein the second web content corresponds to content received by an electronic device located in or near the physical location of the user, and wherein a URL corresponding to the first web content is identical to a URL corresponding to the second web content.

2. The computer-implemented method of claim 1, wherein selecting the accessible server is based on a distance between a physical location corresponding to the selected virtual location and respective physical locations of each of the plurality of the accessible servers.

3. The computer-implemented method of claim 1, wherein the received first web content is identical to web content corresponding to a web browsing application accessing the first web content at the physical location of the selected accessible server.

4. The computer-implemented method of claim 1, further comprising providing an indicator of the selected accessible server's physical location for display on an interface of the web browsing application.

5. The computer-implemented method of claim 4, wherein the indicator is a flag of a country the selected accessible server is physically located in.

6. The computer-implemented method of claim 1, further comprising:
receiving a new user selection of a different virtual location from the plurality of virtual locations; and
selecting a different accessible server from the plurality of accessible servers in or near a physical location corresponding to the new user selected virtual location, and wherein the selected accessible server is a newly selected accessible server.

7. The computer-implemented method of claim 1, wherein the accessible server is a content distribution network.

8. The computer-implemented method of claim 1, wherein the origin server is a local router at the physical location of the user.

9. The computer-implemented method of claim 1, wherein the interface comprises a list of virtual locations.

10. The computer-implemented method of claim 1, wherein the interface is configured to receive a user input of a user designated virtual location.

11. The computer-implemented method of claim 1, wherein the virtual location is a country name.

12. A system for accessing web content, the system comprising:
a memory comprising instructions for accessing web content; and
a processor configured to facilitate:
providing an interface on a web browsing application to display a plurality of virtual locations;
receiving a user selection of a virtual location from the plurality of virtual locations;
selecting an accessible server from a plurality of accessible servers, wherein each of the plurality of accessible servers is located in or near a physical location corresponding to the selected virtual location, wherein selecting the accessible server is based on a distance between a physical location corresponding to the selected virtual location and respective physical locations of each of the plurality of the accessible servers;
establishing a connection with an origin server, wherein the origin server is located in or near a physical location of the user;
requesting the origin server to route a request to access first web content to the selected accessible server, wherein the first web content corresponds to content requested by an electronic device located in or near the physical location corresponding to the selected virtual location;
receiving, in response to the request, the first web content from the selected accessible server, wherein the first web content corresponds to content requested by an electronic device located in or near the physical location corresponding to the selected virtual location; and
providing the received first web content for display on the web browsing application, wherein the first web content is different than second web content, wherein the second web content corresponds to content requested by an electronic device located in or near the physical location of the user, and wherein a URL corresponding to the first web content is identical to a URL corresponding to the second web content.

13. The system of claim 12, wherein the provided first web content is identical to web content that is provided to a web browsing application accessing the first web content at the physical location of the selected accessible server.

14. The system of claim 12, wherein the processor is configured to facilitate providing an indicator of the selected accessible server's physical location for display on an interface of the web browsing application.

15. The system of claim 14, wherein the indicator is a flag of a country the selected accessible server is physically located in.

16. The system of claim 12, wherein the processor is configured to facilitate:
receiving a new user selection of a different virtual location from the plurality of virtual locations; and
selecting a different accessible server from the plurality of accessible servers in or near a physical location corresponding to the new user selected virtual location, and wherein the selected accessible server is a newly selected accessible server.

17. The system of claim 12, wherein the accessible server is a content distribution network.

18. A machine-readable medium comprising machine-readable instructions for accessing web content, the method comprising:
providing an interface on a web browsing application to display a plurality of virtual locations;
receiving a user selection of a virtual location from the plurality of virtual locations;
selecting an content distribution network from a plurality of content distribution networks, wherein each of the plurality of content distribution networks is located in or near a physical location corresponding to the selected virtual location, and wherein selecting the content distribution network is based on a distance between a physical location corresponding to the selected content distribution network and respective physical locations of each of the plurality of the content distribution networks;
establishing a connection with an origin server, wherein the origin server is located in or near a physical location of the user;
requesting the origin server to route a request to access first web content to the selected content distribution network, wherein the first web content corresponds to content received by an electronic device located in or near the physical location corresponding to the selected virtual location;
receiving, in response to the request, the first web content from the selected content distribution network, wherein the first web content corresponds to content received by an electronic device located in or near the physical location corresponding to the selected virtual location;
providing the received first web content for display on the web browsing application, wherein the first web content is different than second web content, wherein the second web content corresponds to content received by an electronic device located in or near the physical location of the user, and wherein a URL corresponding to the first web content is identical to a URL corresponding to the second web content; and
providing an indicator of the selected content distribution network's physical location for display on an interface of the web browsing application; wherein the indicator is a flag of a country the content distribution network is physically located in.

19. The machine-readable medium of claim 18, wherein the provided first web content is identical to web content that is provided to a web browsing application accessing the first web content at the physical location of the selected accessible server.

20. The machine-readable medium of claim 18, wherein the method comprises:
receiving a new user selection of a different virtual location from the plurality of virtual locations; and
selecting a different accessible server from the plurality of accessible servers in or near a physical location corresponding to the new user selected virtual location, and wherein the selected accessible server is a newly selected accessible server.
